(19) United States
(12) Patent Application Publication
(10) Pub. No.: US 2025/0377548 A1
(43) Pub. Date: Dec. 11, 2025

(54) HEAD-MOUNTED DISPLAY DEVICE, AND METHOD AND APPARATUS FOR ADJUSTING WEARING CENTER OF GRAVITY OF HEAD-MOUNTED DISPLAY DEVICE

(71) Applicant: VIVO MOBILE COMMUNICATION CO., LTD., Dongguan (CN)

(72) Inventors: Yongjia SHEN, Dongguan (CN); Huxia KE, Dongguan (CN); Xiaodan ZHENG, Dongguan (CN)

(73) Assignee: VIVO MOBILE COMMUNICATION CO., LTD., Dongguan (CN)

(21) Appl. No.: 19/310,548

(22) Filed: Aug. 26, 2025

Related U.S. Application Data
(63) Continuation of application No. PCT/CN2024/077998, filed on Feb. 22, 2024.

(30) Foreign Application Priority Data
Feb. 28, 2023 (CN) 202310194215.0

(51) Int. Cl. G02B 27/01; G06F 3/01; G06T 11/00

(52) U.S. Cl. CPC G02B 27/0176; G06F 3/012; G06T 11/00; G02B 2027/0154; G06T 2200/24

(57) ABSTRACT

A head-mounted display device and a method and an apparatus for adjusting a wearing center of gravity of a head-mounted display device are provided. The head-mounted display device includes: a head-mounted display body (A); a rear cushion (C); a wearing component (B) connecting the head-mounted display body (A) and the rear cushion (C); and a first accessory (D) arranged on the wearing component (B), where the first accessory (D) is movable on the wearing component (B), and the first accessory (D) is an accessory other than a display module of the head-mounted display device.

### CROSS-REFERENCE TO RELATED APPLICATIONS

This application is a continuation application of PCT International Application No. PCT/CN2024/077998 filed on Feb. 22, 2024, which claims priority to Chinese Patent Application No. 202310194215.0, filed in China on Feb. 28, 2023, which is incorporated herein by reference in its entirety.

### TECHNICAL FIELD

This application belongs to the field of communication technologies, and in particular, to a head-mounted display device, and a method and an apparatus for adjusting a wearing center of gravity of a head-mounted display device.

### BACKGROUND

With the emergence of head-mounted display devices, the head-mounted display devices are applied to a plurality of fields such as virtual reality, augmented reality, and mixed reality. Since functions and components of a device gradually increase, pressure on a head, a face, and cervical spine of a wearer caused by the head-mounted display device also gradually increases. Many head-mounted display devices attempt to reduce the pressure of the head-mounted display device on the face through a method such as placing head-mounted display components (such as batteries) at the back or separating the components, or disperse the pressure by adding forehead straps or forehead weight-bearing masks. All of the above are to improve comfort by changing a center-of-gravity position of the head-mounted display device.

Although the foregoing technology effectively relieves the pressure on the face from the head-mounted display device, an application scenario of a user is limited due to a fixed structure. For example, if a battery is placed at the back, the user cannot use a device in a lying position. In addition, more parts of a device needing to fit the head and the face lead to greater susceptibility to a difference between facial features of a human body. For example, the weight-bearing mask added to the forehead or the rear cushion may affect fitness due to different features such as a head shape and a head circumference of a user, which may affect a weight-bearing effect of an accessory.

### SUMMARY

An objective of embodiments of this application is to provide a head-mounted display device, and a method and an apparatus for adjusting a wearing center of gravity of a head-mounted display device.

According to a first aspect, an embodiment of this application provides a head-mounted display device, including:
a head-mounted display body;
a rear cushion;
a wearing component connecting the head-mounted display body and the rear cushion; and
a first accessory arranged on the wearing component, where the first accessory is movable on the wearing component, and the first accessory is an accessory other than a display module of the head-mounted display device.

According to a second aspect, an embodiment of this application provides a method for adjusting a wearing center of gravity of a head-mounted display device, where the head-mounted display device is the head-mounted display device according to the first aspect.

The method includes:
enabling, through the movement of the first accessory on the wearing component if a distance between a head center-of-gravity position of a user and a center-of-gravity position of the head-mounted display device is greater than a first threshold, the distance between the head center-of-gravity position of the user and the center-of-gravity position of the head-mounted display device to be less than or equal to the first threshold after the user wears the head-mounted display device through the wearing component.

According to a third aspect, an embodiment of this application provides an apparatus for adjusting a wearing center of gravity of a head-mounted display device, where the head-mounted display device is the head-mounted display device according to the first aspect. The apparatus includes:
a moving module, configured to enable, through the movement of the first accessory on the wearing component if a distance between a head center-of-gravity position of a user and a center-of-gravity position of the head-mounted display device is greater than a first threshold, the distance between the head center-of-gravity position of the user and the center-of-gravity position of the head-mounted display device to be less than or equal to the first threshold after the user wears the head-mounted display device through the wearing component.

According to a fourth aspect, an embodiment of this application provides a head-mounted display device, including a processor and a memory, where the memory stores a program or an instruction executable on the processor. The program or the instruction, when executed by the processor, implements the steps of the method according to the second aspect.

According to a fifth aspect, an embodiment of this application provides a readable storage medium. The readable storage medium stores a program or an instruction. The program or the instruction, when executed by a processor, implements the steps of the method according to the second aspect.

According to a sixth aspect, an embodiment of this application provides a chip. The chip includes a processor and a communication interface. The communication interface is coupled to the processor, and the processor is configured to run a program or an instruction to implement the method according to the second aspect.

According to a seventh aspect, an embodiment of this application provides a computer program product. The program product is stored in a storage medium. The program product is executed by at least one processor to implement the method according to the second aspect.

### BRIEF DESCRIPTION OF THE DRAWINGS

FIG. 1 is a schematic structural diagram of a head-mounted display device according to an embodiment of this application;

FIG. 2 is a schematic flowchart of a method for adjusting a wearing center of gravity of a head-mounted display device according to an embodiment of this application;

FIG. 3 is a schematic diagram of a center of gravity of a head in the method for adjusting a wearing center of gravity of a head-mounted display device according to an embodiment of this application;

FIG. 4 is a flowchart of an application example according to an embodiment of this application;

FIG. 5 is a schematic diagram showing calculation of a center of gravity of a head-mounted display device in an application example according to an embodiment of this application; and

FIG. 6 is a schematic structural diagram of an apparatus for adjusting a wearing center of gravity of a head-mounted display device according to an embodiment of this application.

### DETAILED DESCRIPTION

Technical solutions in embodiments of this application are clearly described below with reference to the accompanying drawings in embodiments of this application. Apparently, the described embodiments are merely some rather than all embodiments of this application. All other embodiments obtained by a person of ordinary skill in the art based on embodiments of this application fall within the protection scope of this application.

Terms “first”, “second”, and the like in the specification and the claims of this application are used to distinguish between similar objects, rather than describe a specific sequence or order. It should be understood that data used in this way may be transposed where appropriate, so that embodiments of this application may be implemented in an order different from those illustrated or described herein. In addition, the objects distinguished by “first”, “second”, and the like are generally of the same class and do not limit a quantity of objects. For example, one or more first objects may be arranged. In addition, “and/or” used in the specification and the claims indicates at least one of connected objects. The character “/” generally indicates an “or” relationship between a preceding associated object and a succeeding associated object.

A head-mounted display device and a method and an apparatus for adjusting a wearing center of gravity of a head-mounted display device according to embodiments of this application are described in detail through specific embodiments and application scenarios thereof below with reference to the accompanying drawings.

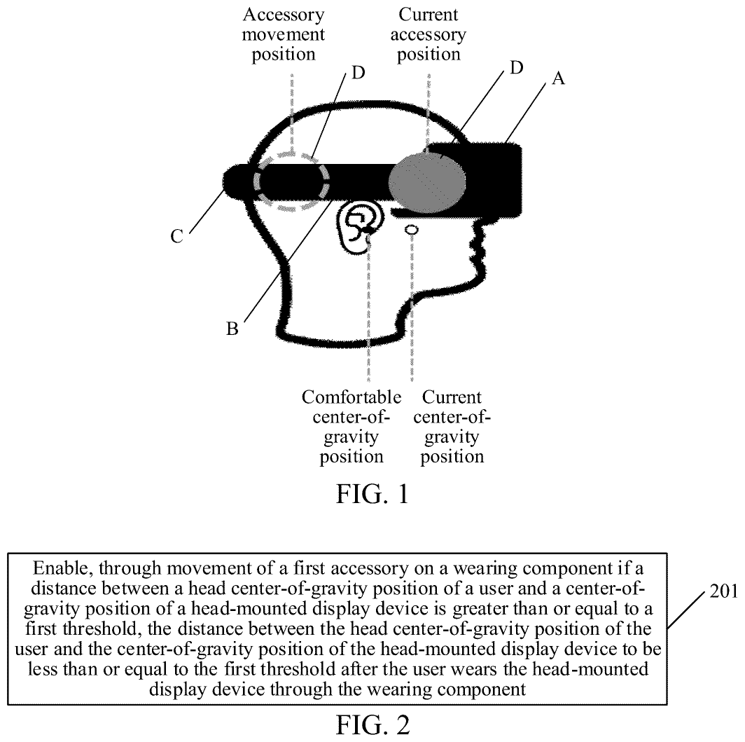

As shown in FIG. 1, an embodiment of this application provides a head-mounted display device, including:
a head-mounted display body A;
a rear cushion C;
a wearing component B connecting the head-mounted display body A and the rear cushion C; and
a first accessory D arranged on the wearing component B, where the first accessory D is movable on the wearing component, and the first accessory D is an accessory other than a display module of the head-mounted display device. Optionally, the first accessory D is a battery.

Optionally, the wearing component B may further be referred to as a headband or a strap.

In this embodiment of this application, a battery having a relatively large weight or another accessory other than the display module is arranged on the wearing component B, and a position thereof may be freely adjusted. Optionally, the position of the first accessory may be positioned through a sensor on the wearing component B.

It should be noted that the position of the first accessory may be manually adjusted by a user, or may be controlled and adjusted by a control module of the head-mounted display device. This is not specifically limited herein.

In an optional embodiment of this application, the head-mounted display device further includes:
a head-mounted display headset arranged on the wearing component, where the head-mounted display headset is movable on the wearing component.

The head-mounted display headset may be a wireless Bluetooth headset, or may be a wired headset. In a case that the head-mounted display headset is a wired headset, a connection line of the wired headset is hidden inside the wearing component, and a length of the connection line of the wired headset is adjustable.

For example, the head-mounted display headset is arranged on the wearing component through a clamping component, and the clamping component may move relative to the wearing component, thereby driving the head-mounted display headset to move.

In another optional embodiment of this application, a length of the wearing component is adjustable. Since different users have different head circumferences, to enable the wearing component to be applicable to different users, the length of the wearing component in this embodiment of this application may be adjusted through a telescopic structure or the like.

For requirements for comfort and convenience of a user when wearing a head-mounted display device, an embodiment of this application provides a head-mounted display device. A first accessory of the head-mounted display device is movable on a wearing component. A center of gravity of the head-mounted display device is adjusted by adjusting a position of the first accessory on the wearing component, so that the center of gravity of the head-mounted display device is close to or coincides with a center of gravity of a head of the user, thereby achieving an objective of comfortable wearing and improving user experience.

To describe the head-mounted display device provided in this embodiment of this application more clearly, a method for adjusting a wearing center of gravity of a head-mounted display device is described in detail with reference to the accompanying drawings.

As shown in FIG. 2, an embodiment of this application provides a method for adjusting a wearing center of gravity of a head-mounted display device, where the head-mounted display device is the head-mounted display device shown in FIG. 1. The method includes the following steps.

Step 201: Enable, through movement of s first accessory on s wearing component if a distance between a head center-of-gravity position of a user and a center-of-gravity position of the head-mounted display device is greater than a first threshold, the distance between the head center-of-gravity position of the user and the center-of-gravity position of the head-mounted display device to be less than or equal to the first threshold after the user wears the head-mounted display device through the wearing component.

Optionally, the first threshold may be equal to 0 or a numerical value slightly greater than 0. This is not specifically limited herein. It should be noted that a smaller distance between a comfortable center-of-gravity position of wearing a head-mounted display device and a center-of-gravity position of a human body, or a smaller offset distance between the entire center of gravity of wearing a head-mounted display indicates higher wearing comfort.

In an optional embodiment, step 201 includes:
displaying a first interface through the head-mounted display body after a user wears the head-mounted display device through the wearing component and turns on the head-mounted display body, where display content of the first interface includes: a head contour of the user, a marked head center-of-gravity position, a current position of the first accessory, a marked center-of-gravity position of the head-mounted display device when the first accessory is in the current position, and a to-be-moved area of the first accessory;
controlling the first accessory to move to the to-be-moved area, or determine, in response to a movement operation of the user, that the first accessory moves to the to-be-moved area, where
when the first accessory moves to the to-be-moved area, the distance between the head center-of-gravity position of the user and the center-of-gravity position of the head-mounted display device is less than or equal to the first threshold.

FIG. 1 shows display content of a first interface. A head center-of-gravity position is marked as a comfortable center-of-gravity position in FIG. 1, a current position of a first accessory is a current accessory position D in FIG. 1, a center-of-gravity position of the head-mounted display device when the first accessory is in the current position is marked as a current center-of-gravity position in FIG. 1, and a to-be-moved area of the first accessory is an accessory movement position D in FIG. 1. The user may move the first accessory based on a prompt, to adjust a center of gravity of the head-mounted display device. Alternatively, the head-mounted display device controls movement of a position of the first accessory to adjust the center of gravity of the head-mounted display device.

Optionally, in a case that movement of the first accessory is performed by the user, the first accessory may be arranged on the wearing component through the clamping component, and the clamping component may move relative to the wearing component, thereby driving the first accessory to move.

Optionally, in a case that the movement of the first accessory is controlled by the head-mounted display device, a guide rail and a motor controlled by a control module of the head-mounted display device may be arranged on the wearing component. The first accessory is arranged on the guide rail and is connected to the motor. The control module drives a roller of the motor to move, thereby driving the first accessory to move on the guide rail, and achieving position adjustment of the first accessory.

Optionally, in at least one optional embodiment of this application, the method further includes:
determining a head circumference of the user based on a length of the wearing component in a case that the user wears the head-mounted display device;
determining a position of a tragion of the user based on a position of a head-mounted display headset of the head-mounted display device and the head circumference of the user; and
determining the head center-of-gravity position of the user based on the position of the tragion of the user.

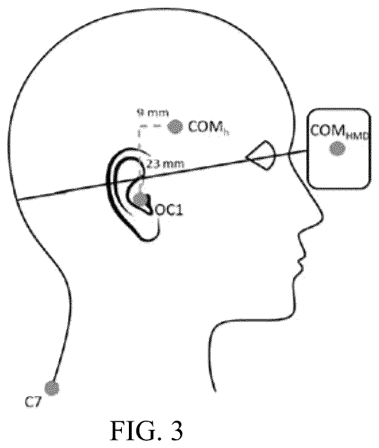

In an optional embodiment of this application, as shown in FIG. 3, it may be learned through literature research that a center of gravity COMh of a human head is 23 mm upward and 9 mm forward from a tragion OC1. For example, a head circumference of a user may be measured based on a length of a wearing component of a head-mounted display device, and a position of the tragion is determined based on a position of a head-mounted display headset of the head-mounted display device. For example, a central position of a head-mounted display headset is determined as the position of the tragion, or a central position of a head-mounted display headset that is 2 mm upward is determined as the position of the tragion. After the position of the tragion is obtained, the tragion OC1 that is 23 mm upward and 9 mm forward is determined as the head center-of-gravity position of the user.

It should be noted that the foregoing specific numerical values such as 2 mm, 23 mm, and 9 mm may be adaptively adjusted based on an actual situation of application. For example, the numerical value is adaptively increased or adaptively decreased. This is not specifically limited herein.

In embodiments of this application, a current center of gravity of the head-mounted display device is first calculated, then a current center of gravity of the head-mounted display device is calculated by adjusting a position of the first accessory, and an adjustment method for the first accessory is displayed on the first interface of the head-mounted display body, so that the center of gravity of the head-mounted display device is close to or coincides with a center of gravity of a head of the user, thereby achieving an objective of comfortable wearing. In addition, in embodiments of this application, the center of gravity of the head-mounted display device is calculated, and the adjustment method is displayed on a display interface of the head-mounted display body, thereby efficiently guiding the user to wear the device to a comfortable position, and improving user experience.

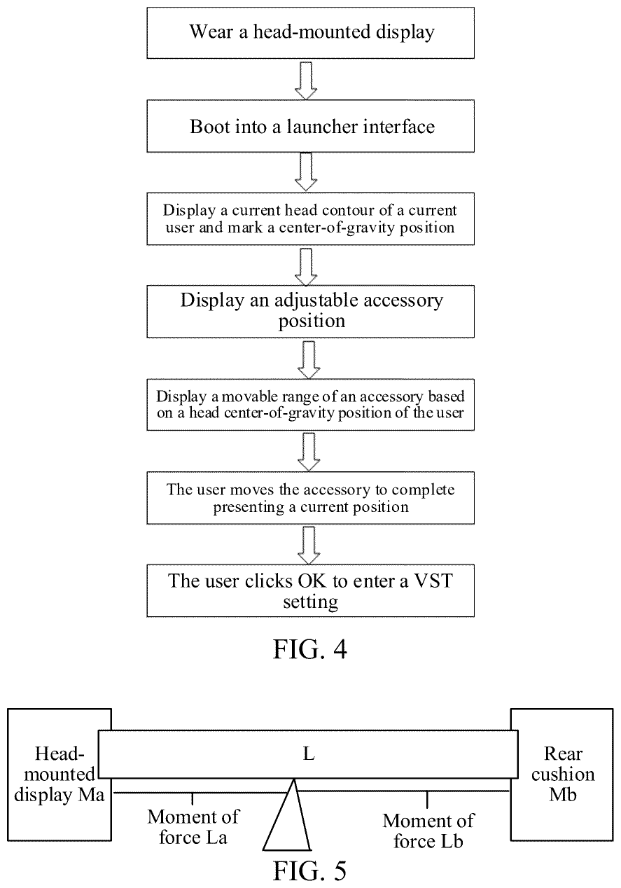

To describe the method for adjusting a wearing center of gravity provided in embodiments of this application more clearly, a description is provided below with reference to an example, as shown in FIG. 4:
1. Wear a head-mounted display: After the user wears the head-mounted display and tightens the headband, the head-mounted display device measures a position of a center of gravity based on preset data depending on a degree of tightness of the headband. A center of gravity of the head-mounted display linearly changes with the degree of tightness of the headband. Therefore, a center-of-gravity position of the head-mounted display corresponding to a tightening position of the headband may be preset in a system, and the accessory should be in an initial position at this time.

Calculation of the center of gravity: Based on the equation of a moment of force Ma*La=Mb*Lb, Ma represents a moment of force on a side a, La represents a moment of force from a point of a center of gravity to the side a, Mb represents a weight on a side b, and Lb represents a moment of force on the side b. As shown in FIG. 5, different degrees of tightness of the user represent changes of L. Center-of-gravity positions of the user under different degrees of tightness may be calculated according to the foregoing equation of the moment of force and weights of the head-mounted display and a rear cushion that have been determined.
2. Boot into a launcher (Android system desktop starter) interface: A user turns on a head-mounted display and then enters a system launcher interface.
3. In this case, a current head contour of the user is presented on an interface, and a head center-of-gravity position is marked.
4. In this case, a virtual center-of-gravity position of the head-mounted display device, a virtual image of the head-mounted display, a virtual image of the first accessory, and an adjustable accessory are further presented on the interface.
5. In this case, the head-mounted display device further presents a movable range of the first configuration based on the head center-of-gravity position of the user, and the user may move the first accessory based on a prompt to adjust the center of gravity.
6. The user moves the accessory to adjust the center of gravity and clicks OK to enter a video see-through (VST) setting of the head-mounted display device.

Based on the above, in embodiments of this application, a current center of gravity of the head-mounted display device is first calculated, then a current center of gravity of the head-mounted display device is calculated by adjusting a position of the first accessory, and an adjustment method for the first accessory is displayed on the first interface of the head-mounted display body, so that the center of gravity of the head-mounted display device is close to or coincides with a center of gravity of a head of the user, thereby achieving an objective of comfortable wearing. In addition, in embodiments of this application, the center of gravity of the head-mounted display device is calculated, and the adjustment method is displayed on a display interface of the head-mounted display body, thereby efficiently guiding the user to wear the device to a comfortable position, and improving user experience.

The method for adjusting a wearing center of gravity provided in embodiments of this application may be performed by an apparatus for adjusting a wearing center of gravity. In embodiments of this application, the apparatus for adjusting a wearing center of gravity provided in embodiments of this application is described through an example in which the apparatus for adjusting a wearing center of gravity performs the method for adjusting a wearing center of gravity.

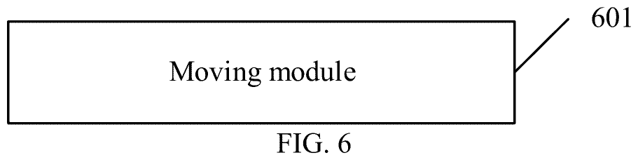

As shown in FIG. 6, an embodiment of this application further provides an apparatus for adjusting a wearing center of gravity of a head-mounted display device, where the head-mounted display device is the head-mounted display device described above. The apparatus includes:

a moving module 601, configured to enable, through the movement of the first accessory on the wearing component if a distance between a head center-of-gravity position of a user and a center-of-gravity position of the head-mounted display device is greater than a first threshold, the distance between the head center-of-gravity position of the user and the center-of-gravity position of the head-mounted display device to be less than or equal to the first threshold after the user wears the head-mounted display device through the wearing component.

In an optional embodiment, the moving module includes:
a display submodule, configured to display a first interface through the head-mounted display body after a user wears the head-mounted display device through the wearing component and turns on the head-mounted display body, where display content of the first interface includes: a head contour of the user, a marked head center-of-gravity position, a current position of the first accessory, a marked center-of-gravity position of the head-mounted display device when the first accessory is in the current position, and a to-be-moved area of the first accessory; and
a moving submodule, configured to control the first accessory to move to the to-be-moved area, or determine, in response to a movement operation of the user, that the first accessory moves to the to-be-moved area, where
when the first accessory moves to the to-be-moved area, the distance between the head center-of-gravity position of the user and the center-of-gravity position of the head-mounted display device is less than or equal to the first threshold.

In an optional embodiment, the apparatus further includes:
a first determining module, configured to determine a head circumference of the user based on a length of the wearing component in a case that the user wears the head-mounted display device;
a second determining module, configured to determine a position of a tragion of the user based on a position of a head-mounted display headset of the head-mounted display device and the head circumference of the user; and
a third determining module, configured to determine the head center-of-gravity position of the user based on the position of the tragion of the user.

In embodiments of this application, a current center of gravity of the head-mounted display device is first calculated, then a current center of gravity of the head-mounted display device is calculated by adjusting a position of the first accessory, and an adjustment method for the first accessory is displayed on the first interface of the head-mounted display body, so that the center of gravity of the head-mounted display device is close to or coincides with a center of gravity of a head of the user, thereby achieving an objective of comfortable wearing. In addition, in embodiments of this application, the center of gravity of the head-mounted display device is calculated, and the adjustment method is displayed on a display interface of the head-mounted display body, thereby efficiently guiding the user to wear the device to a comfortable position, and improving user experience.

The apparatus for adjusting a wearing center of gravity of a head-mounted display device in embodiments of this application may be an electronic device, or may be a component in the electronic device, for example, an integrated circuit or a chip. The electronic device may be a terminal, or may be another device other than the terminal. In an example, the electronic device may be a mobile phone, a tablet computer, a notebook computer, a palm computer, an on-board electronic device, a mobile Internet device (MID), an augmented reality (AR)/virtual reality (VR) device, a robot, a wearable device, an ultra-mobile personal computer (UMPC), a netbook, a personal digital assistant (PDA), or the like, or may be a server, a network attached storage (NAS), a personal computer (PC), a television (TV), a teller machine, an automated machine, or the like. This is not specifically limited in this embodiment of this application.

The apparatus for adjusting a wearing center of gravity of a head-mounted display device in this embodiment of this application may be an apparatus having an operating system. The operating system may be an Android operating system, may be an ios operating system, and may further be another possible operating system. This is not specifically limited in embodiments of this application.

The apparatus for adjusting a wearing center of gravity of a head-mounted display device provided in this embodiment of this application can implement all processes implemented in the method embodiments of FIG. 1 to FIG. 5. To avoid repetition, details are not described herein again.

An embodiment of this application further provides a readable storage medium. The readable storage medium may be a volatile or non-volatile storage medium, and the readable storage medium stores a program or an instruction. The program or the instruction, when executed by a processor, implements the processes of embodiments of the foregoing method for adjusting a wearing center of gravity of a head-mounted display device, and can achieve the same technical effect. To avoid repetition, details are not described herein again.

The processor is a processor in the electronic device in the foregoing embodiment. The readable storage medium includes a computer-readable storage medium, such as a computer read-only memory ROM, a random access memory RAM, a magnetic disk, or an optical disk.

An embodiment of this application further provides a chip. The chip includes a processor and a communication interface. The communication interface is coupled to the processor. The processor is configured to run a program or an instruction, to implement the processes of embodiments of the foregoing method for adjusting a wearing center of gravity of a head-mounted display device, and can achieve the same technical effect. To avoid repetition, details are not described herein again.

It should be understood that the chip mentioned in this embodiment of this application may further be referred to as a system level chip, a system chip, a chip system, a system on chip, or the like.

An embodiment of this application provides a computer program product, stored in a storage medium. The program product is executed by at least one processor to implement the processes of embodiments of the foregoing method for adjusting a wearing center of gravity of a head-mounted display device, and can achieve the same technical effect. To avoid repetition, details are not described herein again.

It should be noted that a term “comprise”, “include” or any other variant herein are intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in implementations of this application is not limited to execution of functions in the order shown or discussed, and may further include execution of functions in a substantially simultaneous manner or in a reverse order based on the functions involved. For example, the described method may be performed in a different order from the described order, and various steps may also be added, omitted, or combined. In addition, features described with reference to some examples may be combined in another example.

Through the descriptions of the foregoing implementations, a person skilled in the art may clearly learn that the method in the foregoing embodiments may be implemented by software with a necessary universal hardware platform, or may be implemented by hardware. However, in many cases, the software with a necessary universal hardware platform is a preferred implementation. Based on such an understanding, the technical solutions of this application, in essence, or a part contributing to the prior art may be embodied in a form of a computer software product. The computer software product is stored in a storage medium (such as a ROM/RAM, a magnetic disk, or an optical disk), including a plurality of instructions for causing a terminal (which may be a mobile phone, a computer, a server, a network device, or the like) to perform the method in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms without departing from the concept of this application and the protection scope of the claims. These forms fall within the protection of this application.

What is claimed is:

1. A head-mounted display device, comprising:
a head-mounted display body;
a rear cushion;
a wearing component connecting the head-mounted display body and the rear cushion; and
a first accessory arranged on the wearing component, wherein the first accessory is movable on the wearing component, and the first accessory is an accessory other than a display module of the head-mounted display device.

2. The head-mounted display device according to claim 1, further comprising:
a head-mounted display headset arranged on the wearing component, wherein the head-mounted display headset is movable on the wearing component.

3. The head-mounted display device according to claim 1, wherein a length of the wearing component is adjustable.

4. A method for adjusting a wearing center of gravity of a head-mounted display device, wherein the head-mounted display device comprises:
a head-mounted display body;
a rear cushion;
a wearing component connecting the head-mounted display body and the rear cushion; and
a first accessory arranged on the wearing component, wherein the first accessory is movable on the wearing component, and the first accessory is an accessory other than a display module of the head-mounted display device,
and the method comprises:
enabling, through the movement of the first accessory on the wearing component if a distance between a head center-of-gravity position of a user and a center-of-gravity position of the head-mounted display device is greater than a first threshold, the distance between the head center-of-gravity position of the user and the center-of-gravity position of the head-mounted display device to be less than or equal to the first threshold after the user wears the head- mounted display device through the wearing component.

5. The method according to claim 4, wherein the enabling, through the movement of the first accessory on the wearing component, the distance between the head center-of-gravity position of the user and the center-of-gravity position of the head-mounted display device to be less than or equal to the first threshold comprises:
displaying a first interface through the head-mounted display body after a user wears the head-mounted display device through the wearing component and turns on the head-mounted display body, wherein display content of the first interface comprises: a head contour of the user, a marked head center-of-gravity position, a current position of the first accessory, a marked center-of-gravity position of the head-mounted display device when the first accessory is in the current position, and a to-be-moved area of the first accessory;
controlling the first accessory to move to the to-be-moved area, or determining, in response to a movement operation of the user, that the first accessory moves to the to-be-moved area, wherein
when the first accessory moves to the to-be-moved area, the distance between the head center-of-gravity position of the user and the center-of-gravity position of the head-mounted display device is less than or equal to the first threshold.

6. The method according to claim 4, further comprising:
determining a head circumference of the user based on a length of the wearing component in a case that the user wears the head-mounted display device;
determining a position of a tragion of the user based on a position of a head-mounted display headset of the head-mounted display device and the head circumference of the user; and
determining the head center-of-gravity position of the user based on the position of the tragion of the user.

7. A head-mounted display device, comprising:
a head-mounted display body;
a rear cushion;
a wearing component connecting the head-mounted display body and the rear cushion;
a first accessory arranged on the wearing component, wherein the first accessory is movable on the wearing component, and the first accessory is an accessory other than a display module of the head-mounted display device; and
a processor and a memory, wherein the memory stores a program or an instruction executable on the processor, wherein the program or the instruction, when executed by the processor, causes the head-mounted display device to perform:
enabling, through the movement of the first accessory on the wearing component if a distance between a head center-of-gravity position of a user and a center-of-gravity position of the head-mounted display device is greater than a first threshold, the distance between the head center-of-gravity position of the user and the center-of-gravity position of the head-mounted display device to be less than or equal to the first threshold after the user wears the head-mounted display device through the wearing component.

8. The head-mounted display device according to claim 7, wherein when enabling, through the movement of the first accessory on the wearing component, the distance between the head center-of-gravity position of the user and the center-of-gravity position of the head-mounted display device to be less than or equal to the first threshold, the program or the instruction, when executed by the processor, causes the head-mounted display device to perform:
displaying a first interface through the head-mounted display body after a user wears the head-mounted display device through the wearing component and turns on the head-mounted display body, wherein display content of the first interface comprises: a head contour of the user, a marked head center-of-gravity position, a current position of the first accessory, a marked center-of-gravity position of the head-mounted display device when the first accessory is in the current position, and a to-be-moved area of the first accessory;
controlling the first accessory to move to the to-be-moved area, or determining, in response to a movement operation of the user, that the first accessory moves to the to-be-moved area, wherein
when the first accessory moves to the to-be-moved area, the distance between the head center-of-gravity position of the user and the center-of-gravity position of the head-mounted display device is less than or equal to the first threshold.

9. The head-mounted display device according to claim 7, wherein the program or the instruction, when executed by the processor, causes the head-mounted display device to further perform:
determining a head circumference of the user based on a length of the wearing component in a case that the user wears the head-mounted display device;
determining a position of a tragion of the user based on a position of a head-mounted display headset of the head-mounted display device and the head circumference of the user; and
determining the head center-of-gravity position of the user based on the position of the tragion of the user.

10. A non-transitory readable storage medium, storing a program or an instruction, wherein the program or the instruction, when executed by a processor of a head-mounted display device, implements the steps of the method for adjusting a wearing center of gravity of a head-mounted display device according to claim 4.

11. The non-transitory readable storage medium according to claim 10, wherein when enabling, through the movement of the first accessory on the wearing component, the distance between the head center-of-gravity position of the user and the center-of-gravity position of the head-mounted display device to be less than or equal to the first threshold, the program or the instruction, when executed by the processor, causes the head-mounted display device to perform:
displaying a first interface through the head-mounted display body after a user wears the head-mounted display device through the wearing component and turns on the head-mounted display body, wherein display content of the first interface comprises: a head contour of the user, a marked head center-of-gravity position, a current position of the first accessory, a marked center-of-gravity position of the head-mounted display device when the first accessory is in the current position, and a to-be-moved area of the first accessory;
controlling the first accessory to move to the to-be-moved area, or determining, in response to a movement operation of the user, that the first accessory moves to the to-be-moved area, wherein
when the first accessory moves to the to-be-moved area, the distance between the head center-of-gravity position of the user and the center-of-gravity position of the head-mounted display device is less than or equal to the first threshold.

12. The non-transitory readable storage medium according to claim 10, wherein the program or the instruction, when executed by the processor of the head-mounted display device, causes the head-mounted display device to further perform:
determining a head circumference of the user based on a length of the wearing component in a case that the user wears the head-mounted display device;
determining a position of a tragion of the user based on a position of a head-mounted display headset of the head-mounted display device and the head circumference of the user; and
determining the head center-of-gravity position of the user based on the position of the tragion of the user.

13. A chip, comprising a processor and a communication interface, wherein the communication interface is coupled to the processor, and the processor is configured to execute a program or an instruction, to implement the steps of the method for adjusting a wearing center of gravity of a head-mounted display device according to claim 4.

14. The chip according to claim 13, wherein when enabling, through the movement of the first accessory on the wearing component, the distance between the head center-of-gravity position of the user and the center-of-gravity position of the head-mounted display device to be less than or equal to the first threshold, the program or the instruction, when executed by the processor, causes the head-mounted display device to perform:
displaying a first interface through the head-mounted display body after a user wears the head-mounted display device through the wearing component and turns on the head-mounted display body, wherein display content of the first interface comprises: a head contour of the user, a marked head center-of-gravity position, a current position of the first accessory, a marked center-of-gravity position of the head-mounted display device when the first accessory is in the current position, and a to-be-moved area of the first accessory;
controlling the first accessory to move to the to-be-moved area, or determining, in response to a movement operation of the user, that the first accessory moves to the to-be-moved area, wherein
when the first accessory moves to the to-be-moved area, the distance between the head center-of-gravity position of the user and the center-of-gravity position of the head-mounted display device is less than or equal to the first threshold.

15. The chip according to claim 13, wherein the program or the instruction, when executed by the processor, causes the head-mounted display device to further perform:
determining a head circumference of the user based on a length of the wearing component in a case that the user wears the head-mounted display device;
determining a position of a tragion of the user based on a position of a head-mounted display headset of the head-mounted display device and the head circumference of the user; and
determining the head center-of-gravity position of the user based on the position of the tragion of the user.

16. A computer program product, stored in a non-volatile storage medium, wherein the computer program product is executed by at least one processor to implement the steps of the method for adjusting a wearing center of gravity of a head-mounted display device according to claim 4.

17. The computer program product according to claim 16, wherein the enabling, through the movement of the first accessory on the wearing component, the distance between the head center-of-gravity position of the user and the center-of-gravity position of the head-mounted display device to be less than or equal to the first threshold comprises:
displaying a first interface through the head-mounted display body after a user wears the head-mounted display device through the wearing component and turns on the head-mounted display body, wherein display content of the first interface comprises: a head contour of the user, a marked head center-of-gravity position, a current position of the first accessory, a marked center-of-gravity position of the head-mounted display device when the first accessory is in the current position, and a to-be-moved area of the first accessory;
controlling the first accessory to move to the to-be-moved area, or determining, in response to a movement operation of the user, that the first accessory moves to the to-be-moved area, wherein
when the first accessory moves to the to-be-moved area, the distance between the head center-of-gravity position of the user and the center-of-gravity position of the head-mounted display device is less than or equal to the first threshold.

18. The computer program product according to claim 16, wherein the method for adjusting a wearing center of gravity of a head-mounted display device further comprises:
determining a head circumference of the user based on a length of the wearing component in a case that the user wears the head-mounted display device;
determining a position of a tragion of the user based on a position of a head-mounted display headset of the head-mounted display device and the head circumference of the user; and
determining the head center-of-gravity position of the user based on the position of the tragion of the user.
